(19) United States
(12) Patent Application Publication
(10) Pub. No.: US 2013/0008090 A1
(43) Pub. Date: Jan. 10, 2013

(54) CLOSURE ARRANGEMENT

(76) Inventors: Thomas Lanzl, Marklredwitz (DE); Frank Pohlmann, Rehau (DE)

(21) Appl. No.: 13/635,686

(22) PCT Filed: Feb. 5, 2011
(86) PCT No.: PCT/EP2011/000544

§ 371 Date: Sep. 18, 2012

(30) Foreign Application Priority Data
Mar. 26, 2010 (DE) 202010004307.7

(51) Int. Cl. E05D 15/06; F16C 32/04

(52) U.S. Cl. 49/413

(57) ABSTRACT

A closure arrangement (1) is provided for an opening (2) of a cabinet, a refrigerator, a building or the like, having at least one closure element (4) which is guided in a moveable manner, in particular in or on at least one guide element (3), over the opening (2). At least one free end of the closure element (4) and/or one free end of the guide element (3) are operatively connected to one another by means of a magnetic attraction force, provided by at least one a magnet (5).

The invention relates to a closure arrangement for an opening of a cabinet, a refrigerator, a building and the like, according to the features of the preamble of claim 1.

Such closure arrangements are already described in the prior art.

DE 102009016208 A1, for example, discloses a closure arrangement for refrigerators. This closure arrangement has a first and a second cover part of which at least one cover part is movable, and wherein in the closed state, said cover parts lie in one plane. In this sliding cover system, guiding the movable cover part is implemented via rollers which run in one or a plurality of roller conveyors. This is intended to reduce friction during the movement of a cover part and to provide the possibility of optimal sealing and precise guidance of the cover. The closure arrangements are designed such that they are to be operated manually by the user in that the cover part to be opened in each case can be moved manually from a closed position into an open position.

It is considered to be a disadvantage of this closure arrangement for refrigerators that by manually moving the cover parts from a closed position into an open position, although the items accommodated in the refrigerator can indeed be removed, due to the rollers used, very high sliding forces for the closure elements occur during the movement which make it difficult for the user to move the individual cover parts in a simple manner.

Another disadvantage of the closure arrangement according to the prior art is that improving the movement of the cover parts by using rollers mounted with ball bearings increase the costs of such a refrigerator without significantly reducing the sliding forces for the closure elements. Furthermore, it is considered to be disadvantageous that when used over extended periods of time, the roller conveyors can get contaminated by dust or also fine-grained materials such as, for example, sugar, salt and the like penetrating into said roller conveyors thereby causing an increase of the sliding forces for the closure elements, or blocking the rollers altogether. Likewise, a disadvantage of these refrigerators is that for filling the shelves positioned behind or above the refrigerator, the refrigerators are used by personnel in such a manner that they step onto the closure arrangement. Through the weight of the persons standing on the closure arrangement, the rollers are exposed to high forces which, on the one hand, can result in damage to the rollers or the roller conveyors and, on the other, in damage to the cover parts themselves.

Another closure arrangement for refrigerators is disclosed in DE 10118437 A1. This refrigerator, which is also referred to as a goods display cabinet, has a goods compartment opening which can be at least partially closed by means of one or a plurality of moveable sliding lids. Furthermore, this refrigerator comprises means for automatically moving the sliding lid or sliding lids, wherein said means can be designed as a cable and/or belt system with which the sliding lid or lids can be moved via the cable and/or belt system by means of a drive mechanism. It is further disclosed that moving the sliding lid from a closed position into an open position can he carried out by gearwheels and/or direct toothed rack drives, or also by friction wheel drives and/or via hydraulic or pneumatic cylinders.

The disadvantages of these motor-driven closure arrangements are, one the one hand, very high acquisition costs and also maintenance costs, as well as high susceptibility to failures in continuous operation.

Another disadvantage is that in the case of such closure arrangements, the guide elements on which, for example, the rollers of the door elements are mounted or run, are never exactly aligned horizontally or parallel to each other, The drive devices such as, for example, spiral springs, closing weights, ropes etc., required for closing the door elements have to be dimensioned such that the door elements still close reliably even under these unfavorable conditions. Disadvantageously, this leads to the fact that these drive devices are oversized which, on the one hand, increases costs and, on the other, results in the door elements hitting against the side wall when closing the door elements.

Another closure arrangement, e.g., for cabinets, is disclosed in DE 29907856 U1.

Here what is described is a closure arrangement for receiving gliding and sliding elements such as, for example, blinds, roller shutters or sliding doors, in at least one U-shaped guide rail on furniture, comprising a base profile which can be fastened to the furniture body and a cover profile which can be connected to said base profile for covering the fastening means of the base profile on the furniture body.

It shall be possible to produce this closure arrangement for generic cabinets in an inexpensive manner and to adapt it in a simple manner to the respective purpose of use, and therefore to principally provide an option for receiving different gliding or sliding elements. This is intended to be implemented in that the slideway is formed in a separate rail element which is detachably inserted in a recess of the base profile.

It is considered to be a disadvantage of this guiding device for cabinets that providing a base profile as well as a cover profile and an additional rail element results in excessively high production and assembly costs, and in considerable logistics expenses for warehousing. This is in particular the case in consideration of the fact that different cabinet dimensions with different decors have to be equipped with such guiding devices.

Another disadvantage lies in the fact that the base profile and the associated rail element can only be used for a defined width of gliding and sliding elements.

Also, disadvantageously, the closure arrangement can only be mounted on such cabinets on which the gliding and sliding elements are movable before the body of the cabinet. For the installation of gliding and sliding elements such as, for example, blinds or roller shutters which are to be movable inside the body of the cabinet, these closure arrangements cannot be used.

Furthermore, a disadvantage of the prior art is seen in the fact that when using gliding and sliding elements with the closure arrangement such as, for example, blinds or roller shutters, specific deflection elements have to be mounted such as, for example, guide spirals or angled elements, in which these gliding and sliding elements have to be received in the cabinet interior.

When using the closure arrangement according to the prior art, considerable assembly and customization efforts must be implemented here in order to adapt the guiding device to the corresponding gliding and sliding elements as well as to the body of the cabinet. This relates to the base profile and also the cover profile as well as to the rail elements to be inserted separately and also to end pieces to be inserted at the free ends of the guiding device.

Likewise, it is seen to be disadvantageous that the forces for displacing the gliding and sliding elements in the closure arrangement are very high, and due to abrasion on the individual elements or contamination due to lubricants in the guide rails, result in the same disadvantages as the closure arrangements for refrigerators.

This is where the invention applies, having the object of overcoming the disadvantages of the prior art, and providing a closure arrangement which can he produced in an economic and cost-effective manner, which enables a low-noise, fast and smooth closing movement of the door elements, which can also be cost-effectively retrofitted on already existing openings, which is attractive in appearance or has a changeable look or design, and which has a long operating life.

According to the invention, this object is achieved by the features of claim 1. Further advantageous configurations of the invention are described in the sub-claims.

The closure arrangement according to the invention for an opening of a cabinet, a refrigerator, a building and the like, has at least one closure element which is guided in a moveable manner, in particular in or on at least one guide element, over the opening, is characterized in that at least one free end of the closure element and/or one free end of the guide element are operatively connected to one another by means of a magnetic attraction force, provided by at least one magnet. In this way it can advantageously be achieved that the sliding forces for the closure elements are significantly reduced, in the order of approximately 20 to 95%, preferably 50 to 80%. Another advantage is seen in the fact that the closure arrangement according to the invention shows considerably reduced wear of the individual elements.

It was found to be advantageous that the magnet is arranged on the closure element and/or on the guide element. In this manner, it is advantageously possible, depending on geometry or weight of the individual closure elements, to provide a low-maintenance and cost-effective closure arrangement which optimally closes the openings of cabinets, refrigerators, buildings and the like.

Furthermore, it was found to be advantageous that the magnet is designed as a permanent magnet and/or an electromagnet, wherein the permanent magnet consists of a magnetically hard material. Advantageously, the magnet is axially magnetized. In this way it is possible to cost-effectively produce new closure elements according to the invention for opening or closing openings, but also to inexpensively retrofit or renovate already existing openings of cabinets, refrigerators, buildings and the like with a closure arrangement according to the invention.

It was also found to be advantageous that the magnet is made of metallic alloys of iron and/or nickel and/or cobalt with additions of aluminum and/or manganese and/or silicon and/or copper; of ferrites based on metal oxides such as barium hexaferrite, strontium hexaferrite; of samarium cobalt; of neodymium-iron-boron; of mixtures thereof with polymeric materials; and of combinations thereof with one another and the like,

Thus, the production costs for such magnets can be optimally structured corresponding to the requirements such as, for example, the weight of the closure elements and the geometry of the openings of a cabinet, a refrigerator, a building or the like by using inexpensive magnets with a sufficient adhesive or coercive force.

The closure arrangement according to the invention is further characterized in that the closure element and/or the guide element consist at least partially of a ferromagnetic material. In this way, the interplay between the closure elements and the required guide elements can be dimensioned in a sufficient and low-maintenance manner.

In another advantageous configuration, the closure arrangement according to the invention is designed such that the closure element and/or the guide element have at least partially a ferromagnetic element.

Advantageously, the closure arrangement according to the invention can also be designed such that the closure element is arranged spaced apart from the guide element. As a result, the individual closure elements of the closure arrangement according to the invention can be moved easier and with very low sliding forces for the closure elements.

The closure arrangement according to the invention further comprises at least one spacer element on the closure element and/or on the guide element. This makes it advantageously possible to provide a closure element which, besides a full-surface contact of the closure elements on the guide elements, also implements a punctiform contact resulting in sliding forces for the closure elements that are further reduced.

In another advantageous embodiment of the closure arrangement according to the invention, at least one sealing element is arranged on the closure element and/or the guide element. This results advantageously in the fact that, for example, when using the closure arrangement in a refrigerator, the cooled air in the interior cannot escape through the closure arrangement into the heated sales room.

Another advantage of the closure arrangement according to the invention is the fact that at least one free end of the closure element is operatively connected to the guide element by means of at least one magnet comprising magnetically hard and or magnetically soft materials, and that the sealing element is adequately relieved from pressure so that the sliding threes for the closure elements are reduced again.

In this connection it was found that the sealing element seals a gap between the closure element and the guide element in an air-tight and/or liquid-tight manner so that, for example, energy costs are reduced when using the closure arrangement according to the invention in a refrigerator.

Furthermore, it is of advantage that the sealing element is made from an elastic material and has at least one sliding element. In addition to the simple manufacturing process for such sealing elements, this results in optimal sealing functions and reduced sliding forces for closure elements.

The use of the closure arrangement according to the invention for an opening of a cabinet, a refrigerator, a building and the like therefore results in a significant reduction of the sliding forces for closure elements and compared to the prior art, in particular when using rollers, results in that no permissible wear parts are integrated and, moreover, that no damage to the closure arrangement according to the invention takes place in the event of improper access by personnel.

Furthermore, it is seen to be advantageous that integrating self-closing mechanisms which are based on storing energy such as, e.g., springs or weights, is possible without the sliding forces for closure elements being increased with respect to the solutions of the prior art.

Another advantage of the closure arrangement according to the invention is seen in the fact that compared to the previously used linear mounting and the repulsive method used in this connection, a considerable reduction of the required number or amount of magnets is now possible, resulting in a reduction of costs for the closure arrangements according to the invention.

The use of the closure arrangement according to the invention for an opening of a cabinet, a refrigerator, a building and the like, having at least one closure element which is guided in a moveable manner, in particular in or on at least one guide element, over the opening, wherein at least one free end of the closure element and/or one free end of the guide element are operatively connected to one another by means of at least one magnet comprising magnetically hard or magnetically soft materials, results in the fact that, e.g., by using a ferromagnetic element for the closure element and/or the guide element, due to said the ferromagnetic element, an opposite pole is induced by the magnet in the closure element and/or the guide element.

The attractive forces generated according to the invention in this manner and acting on the closure element and/or the guide element counteract the naturally acting weight force of the latter so that the normal forces acting on the support surfaces are considerably reduced which, in turn, results in a reduction of the sliding forces for closure elements.

Advantageously, a spacer element arranged on the closure element and/or the guide element can prevent the closure element and/or the guide element from adhering to the ferromagnetic element.

The closure arrangement according to the invention shall now be described in more detail by means of exemplary embodiments which, however, are not limiting the invention.

In the figures:

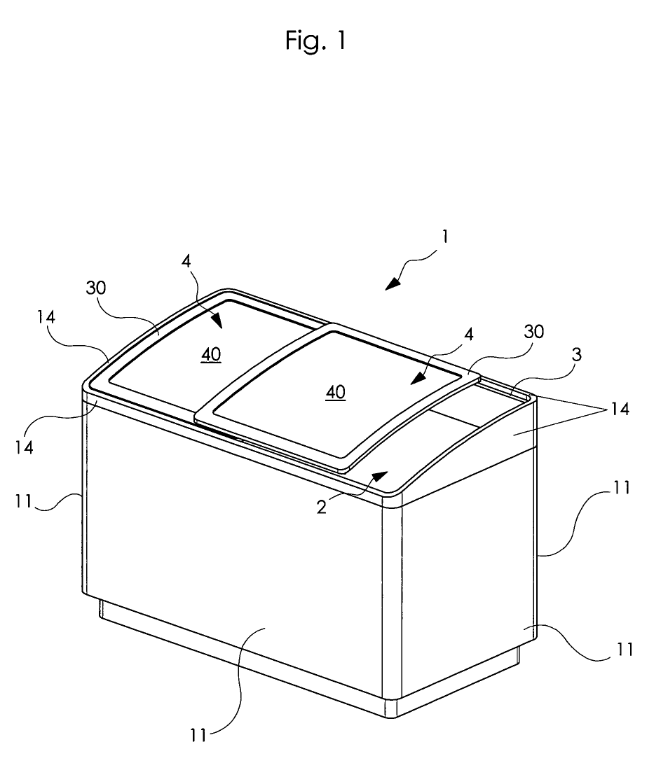

FIG. 1 shows a perspective view of a refrigerator having a closure arrangement according to the invention

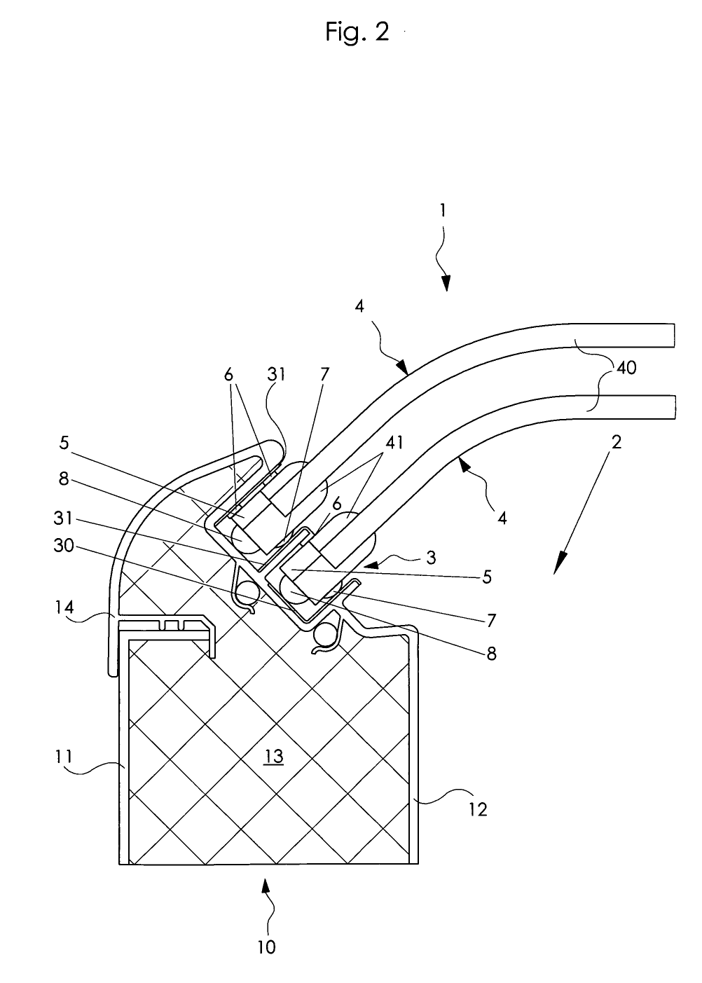

FIG. 2 shows a sectional view of a wall of a refrigerator having a closure arrangement according to the invention

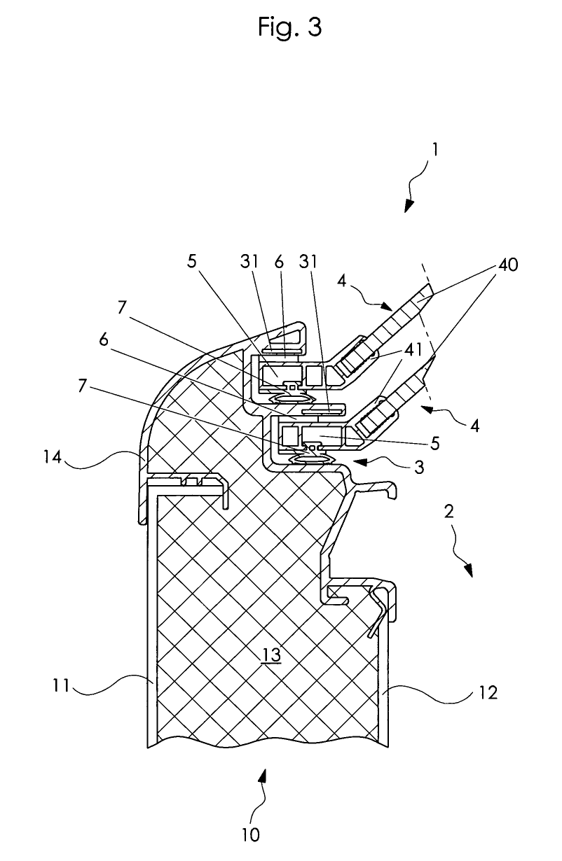

FIG. 3 shows a sectional view of a wall of another refrigerator having a closure arrangement according to the invention.

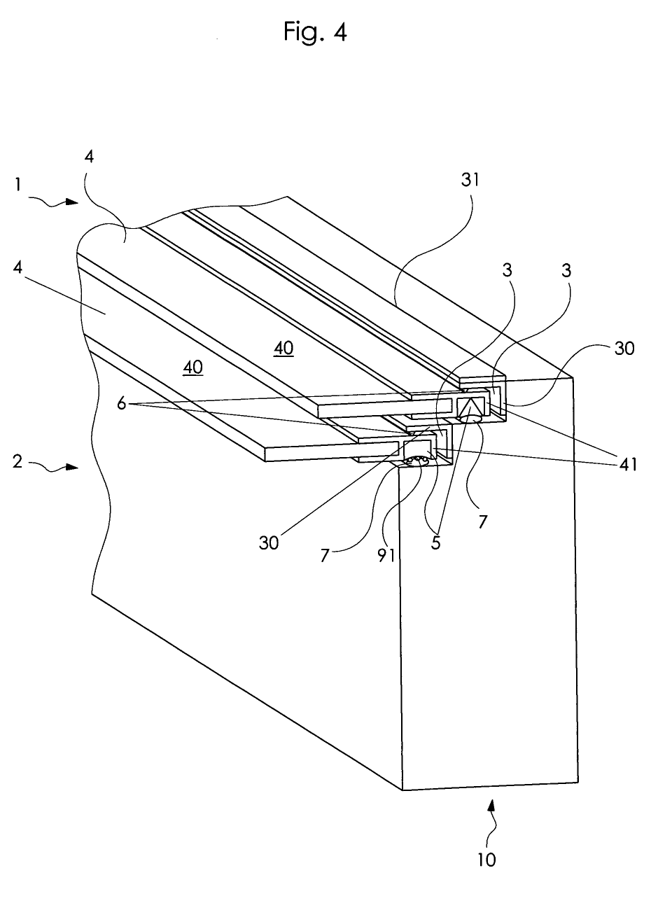

FIG. 4 shows a sectional view of a wall of another refrigerator having a closure arrangement according to the invention

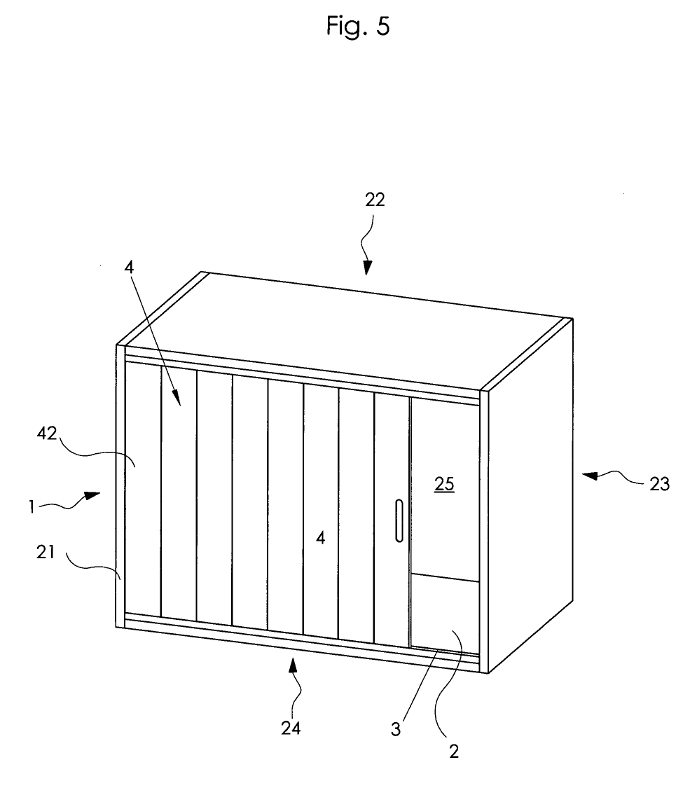

FIG. 5 shows a perspective illustration of a cabinet having a closure arrangement according to the invention.

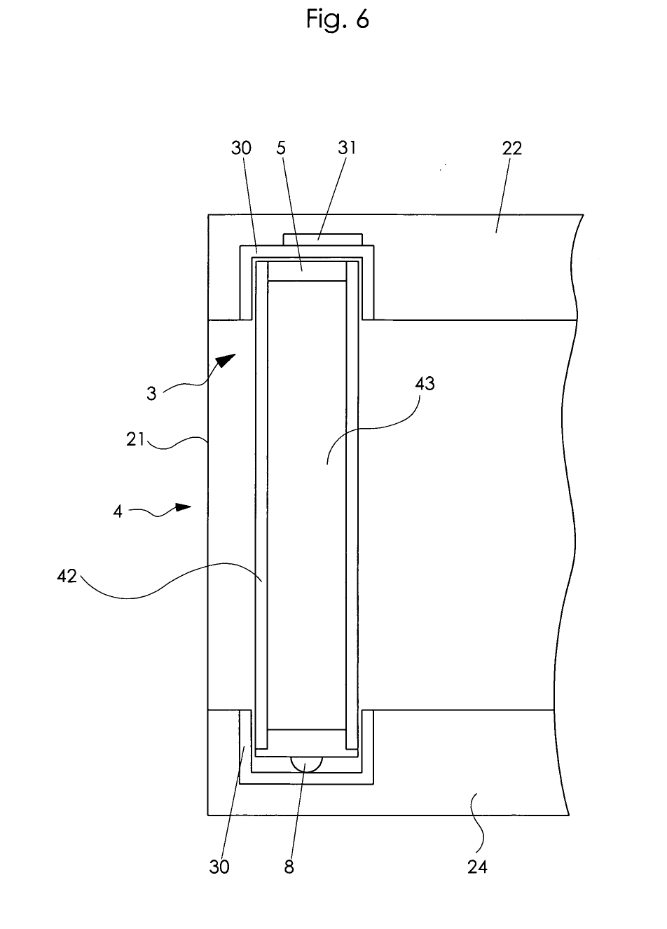

FIG. 6 shows a sectional view of a wall of a cabinet having a closure arrangement according to the invention.

FIG. 1 illustrates a closure arrangement 1 for an opening 2 of a refrigerator. The refrigerator known per se has a total of four outer walls 11 which, through their rectangular arrangement to one another, form the storage room for refrigerated goods. The opening 2 of the refrigerator is covered by a closure arrangement 1 which, in this exemplary embodiment, consists of two closure elements 4 which are movable relative to one another and are mounted to be guided in guide elements 3 which, in turn, are arranged in frame elements 14 attached to the outer walls 11. In this exemplary embodiment, the closure elements 4 are designed such that they consist of a four-sided frame from a first profiled element 30, said frame comprising a plate 40 made from a transparent glass material. The closure elements 4 are arranged horizontally in the guide elements 3 and are movable. relative to one another.

FIG. 2 illustrates a sectional view of a wall 10 of a refrigerator according to FIG. 1 having a closure arrangement 1 according to the invention. The wall 10 of the refrigerator consists of an outer wall 11, an inner wall 12 and an insulation element 13 arranged therebetween. On the narrow side of the wall 10, a frame element 14 is arranged which, in this exemplary embodiment, overlaps the free end of the inner wall 11 and the free end of the inner wall 12.

The closure arrangement 1 for the opening 2 of the refrigerator has two closure elements 4 which are guided over the opening 2 in a movable manner in the guide element 3. In this exemplary embodiment, the guide element 3 is designed such that it has two approximately U-shaped guideways arranged adjacent to one another.

Magnets 5 configured as permanent magnets and consisting of neodymium-iron-boron are arranged at the free ends of the closure, element 4. In this exemplary embodiment, the magnets 5 are integrated in the second profiled element 41 and extend over the entire length or depth, which is not illustrated here, of the closure element 4. A strip 31 is arranged approximately opposite the magnet 5 in the approximately U-shaped guideway of the guide element 3, wherein said strip likewise extends over the non-illustrated length of the frame element 14 of the refrigerator, Arranged between the strip 31 and the second profiled element 41 are spacer elements 6 which are partially or punctiformly arranged on the strip 31.

Arranged on the second profiled element's 41 side opposing the spacer element 6 is a sealing element 7 which seals the gap to the interior of the refrigerator in an air-tight and liquid-tight manner.

In this exemplary embodiment, the closure arrangement 1 consist of two closure elements 4 which are arranged approximately parallel to one another and spaced apart from one another, and are arranged to be movable relative to one another. Here, the first closure element 4 is arranged above the second closure element 4.

In this exemplary embodiment, the guide element 3 is arranged in the frame element 14 of the refrigerator.

At its free end, the second closure element 4 also has a second profiled element 41 on which the magnet 5 is arranged. In this exemplary embodiment, a first profiled element 30 is arranged in the U-shaped guideway of the guide element 3 for the second closure element 41, wherein viewed in cross-section, said first profiled element has an approximately rectangular shape. This first profiled element 30 serves for guiding the sliding element 8 of the second closure element 41, wherein the sliding element rests against the profiled element.

Arranged on the side of the U-shaped guideway of the guide element 3, which side is arranged opposite the magnet 5, there is a spacer element 6 which extends over the entire length, which is not visible here. In the U-shaped guideway of the guide element 3 in which the first closure element 4 is arranged, a strip 31 is arranged opposite the sealing element 7 of the second profiled element 41.

Thus, the free end of the second closure element 4 is operatively connected to the guide element 3 by means of the magnet 5 which consists of a magnetically hard material. Due to force of the magnet 5 of the closure elements 4 which are attracted to the strip 31 arranged in the guide element 3, the weight force of the closure arrangement 1 formed from the first closure element 4 and the second closure element 4 is reduced so that the closure arrangement 1 can be moved smoothly and without problem in the guide element 3.

The magnet 5 of the first closure element 4 is arranged such that the polarity of the north pole is aligned directly opposite the strip 31 which is arranged spaced apart by means of the spacer element 6 in the guide element 3, whereas the south pole is located at the opposite position of the magnet 5. The magnet 5 of the second closure element 4 is arranged such that the polarity of the south pole is aligned opposite the second strip 31 arranged in the guide element 3 so that the south pole of the magnet 5 of the second closure element 4 is arranged directly opposite the south pole of the magnet 5 of the first closure element 4. With this advantageous configuration it is avoided that the attractive forces of the magnets 5 interfere with each other,

The strip 31 arranged in the guide element 3 is formed as a magnetically soft element; in this case from a soft iron.

However, it lies also within the scope of the invention that the magnet 5 is arranged on the guide element 3, and a ferromagnetic element formed as a strip 31 is arranged on the closure element 4.

FIG. 3 illustrates a sectional view of a wall 10 of another refrigerator having a closure arrangement 1 according to the invention. The wall 10 of the refrigerator consists of an outer wall 11, an inner wall 12 and an insulating element 13.

Arranged on a narrow side of the wall 10 is a frame element 14 which overlaps the free end of the outer wall 11 and the free end of the inner wall 12.

The closure arrangement 1 for the opening 2 of the refrigerator has two closure elements 4 which are guided in the guide element 3.

In this exemplary embodiment, the guide element 3 is designed such that it has two approximately U-shaped guideways arranged one below the other.

In this exemplary embodiment, the closure arrangement I according to the invention has a first closure element 4 which is movably arranged above a second closure element 4 in the guide element 3.

In this exemplary embodiment, the first and the second closure elements 4 are designed such that at their free ends, there is a second profiled element 41 on which a plate 40 is arranged which consists of glass.

The second profiled element 41 of the closure elements 4 in this exemplary embodiment is formed in cross-section as a hollow profile and has an opening at its lower side in which a sealing element 7 is inserted.

Opposite the sealing element 7 of the second profiled element 41, a strip 31 is arranged in the U- shaped guide way of the guide element 3. This strip 31 of the guide element 3 is embedded in the respective wall of the frame element 14 made of plastic and is covered toward the guide element 3 by a thin plastic layer. The strip 31 is covered over its entire length or depth, which is not illustrated here, by a plurality of spacer elements 6 which are arranged spaced apart from one another in the longitudinal direction of the second profiled element 41. The spacer elements 6 are arranged on the second profiled element 41.

In the second profiled element 41 of the closure elements 4, in each case four magnets 5 are arranged over the entire length of the refrigerator, wherein in the longitudinal direction of the profile, only the hollow chamber of the second profiled element 41 is arranged between said magnets.

Due to the attractive force provided by the magnets 5, the closure elements 4 are attracted in each case toward the strip 31 arranged in the guide element 3 so that the sealing element 7 arranged on the second profiled element is relieved from pressure and the closure elements 4 can be easily moved without high sliding forces in the guide element 3.

In this exemplary embodiment, the strips 31 arranged in the guide element 3 are arranged laterally offset to one another so that the operative connections, created through the attractive force of the magnets 5, between the free end of the first and the second closure elements 4 and the strip 31 arranged in the guide element 3 act independent from one another and without influencing each other.

The magnets 5 which arranged in the second profiled element 41 of the closure elements 4 are designed in this exemplary embodiment as axially magnetized permanent magnets and are made from neodymium-iron-boron.

However, it lies also within the scope of the invention that the magnets 5 are arranged in the U-shaped guideways of the guide element 3, and that, for example, a magnetically soft strip made of iron and formed as a ferromagnetic element is arranged on or in the second profiled element 41 of the closure elements 4.

FIG. 4 illustrates a sectional view of a wall 10 of another refrigerator having a closure arrangement I according to the invention. In this exemplary embodiment, the refrigerator has a single-layered wall 10 which has guide elements 3 which are arranged thereon in an approximately stair-like manner.

The closure arrangement 1 in this exemplary embodiment consists of two closure elements 4 which close an opening 2 of the refrigerator and are slideably mounted in the guide elements 3. At least one free end of the closure elements 4 is operatively connected to the guide element 3 by means of at least one magnet 5. In this exemplary embodiment, the magnet 5 is arranged on the free end of the closure element 4.

However, it lies also within the scope of the invention that the magnet 5 is arranged on the guide element 3.

In this exemplary embodiment, the closure arrangement 1 consists of two closure elements 4 arranged to he moveable relative to one another, wherein a first closure element 4 is movably arranged above the second closure element 4 in the guide element 3. The first and the second closure elements 4 are designed in this exemplary embodiment in such a manner that, at their free ends, they have a second profiled element 41 made from a polymeric material, wherein in the second profiled element 41, which has an approximately U-shaped cross-section in this exemplary embodiment, magnets 5 are arranged which are partially spaced apart from each other.

Arranged on the guide element's 3 side opposite the second profiled element 41 there are sealing elements 7 which are made from an elastic material and which have sliding elements 91 on their upper side opposing the second profiled element 41.

Opposite to the second profiled element 41 of the second closure element 4, the first profiled element 30 is arranged which consists of a metallic material and is designed as a ferromagnetic element.

Arranged between the first profiled element 30 and the second profiled element 41 there are spacer elements 6 which are punctiformly spaced apart from one another and fastened on the second profiled element 41.

The magnets 5 partially arranged in the second profiled element 41 are therefore operatively connected to the guide element 3 which, as a first profiled element 30, is made from a ferromagnetic material. The second closure element 4 is pulled by the attractive force against the spacer elements 6 toward the first profiled element 30 so that the sealing element 7 arranged on the wall 10 of the refrigerator is relieved from pressure, and the sliding forces for closure elements are considerably reduced for the second closure. element 4.

In this exemplary embodiment, the first closure element 4 has a second profiled element 41 which is formed analogously to the second profiled element 41 of the second closure element 4. In this exemplary embodiment, the second profiled element 41 of the first closure element 4 is made from a ferromagnetic material and surrounds a plate 40 made of transparent glass on all four sides.

The free end of the first closure element 4 is operatively connected to the guide element 3 by means of a magnet 5 made from a magnetically hard material.

In this exemplary embodiment, the guide element 3 has a first profiled element 30 which is formed approximately rectangular in cross-section and consists of a polymeric material.

Spacer elements 6 are arranged on the profile element's 30 side facing the second profiled element 41. On the side opposite the spacer elements 6 of the first profiled element 30, a strip 31 is arranged which is made from a magnetically soft material such as iron.

Thus, the free end of the first closure element 4 is operatively connected via the magnet 5, due to the attractive forces of the magnet 5, to the strip 31 on the first profiled element 30 which is designed as a guide element 3.

Thus, the first closure element 4 is arranged in the guide element 3 to be. easily movable without the need of high cover sliding forces.

By means of the closure arrangement 1 according to the invention, an opposite pole is induced in the closure element 4 as a result of the interaction with the free ends of the closure element 4, the magnet 5 and the guide element 3.

The resulting attractive forces according to the invention acting on the closure element 4 counteract exactly the natural weight force of the closure elements 4 so that the normal forces acting on the contact surfaces, for example, of the sealing elements, are significantly reduced which, in turn, results in a reduction of the sliding forces for closure elements 4 of the closure arrangement 1 according to the invention. Advantageously, a spacer element 6 arranged on the closure element 4 and/or the guide element 3 can prevent a closure element 4 from adhering to the guide element 3 designed as a ferromagnetic element.

FIG. 5 shows a perspective illustration of a cabinet having a closure arrangement 1 according to the invention. The cabinet has a bottom panel 24 to which the side wall 21, the side wall 23 and the rear wall 25 are fastened. The top panel 22 is arranged between the free ends of the side walls 21, 23 and the rear wall 25. The bottom panel 24, the side walls 21, 23 and the top panel 22 border an opening 2 of the cabinet.

The opening 2 of the cabinet is provided with a closure arrangement 1 according to the invention which has a closure element 4 which is arranged in two guide elements 3 to be movable over the opening 2, and wherein the closure element 4 in this exemplary embodiment is formed from a plurality of third profiled elements 42 which are connected to one another. The closure element 4 is arranged horizontally movable in the guide elements 3 in the opening 2 of the cabinet 1 and can be moved from a non-illustrated closed position into an open position.

FIG. 6 illustrates a sectioning of a site view of the cabinet. Here, the side wall 21 is shown on which the top panel 22 and the bottom panel 24, opposite thereto, are arranged.

A first profiled element 30 designed as a guide element 3 is arranged in the top panel 22, wherein said first profiled element has an approximately U-shaped cross-section and is inserted in a groove of the top panel 22 of the cabinet.

A free end of the closure element 4 which, in this exemplary embodiment, is a third profiled element 42 designed as a hollow profile is arranged in the first profiled element 30, which is designed as a guide element 3.

A magnet 5 made from a ceramic material is arranged in the hollow space 43 at the free end of the third profiled element 42 which is designed as a closure element 4.

A strip 31 which, in this exemplary embodiment, is made from a ferromagnetic material is arranged on the first profiled element 30 so that the free end of the third profiled element 42 designed as a closure element 4 is operatively connected via the magnet 5 to the strip 31 arranged on the first profiled element 30 which is designed as a guide element 3. in this exemplary embodiment, the magnet 5 is made from a magnetically hard material such as neodymium-iron-boron.

The closure arrangement 1 according to the invention is characterized in that due to at least one strip 31 made from a ferromagnetic material and arranged on the first profiled element 30 designed as a guide element 3, an opposite pole is induced by the magnet 5 in the third profiled element 42 designed as a closure element 4, due to the strip 31 designed as a ferromagnetic element.

The attractive forces generated in this manner in the closure arrangement 1 according to the invention act on the third profiled element 42 designed as a closure element 4 and counteract the natural weight force of the latter so that the normal forces acting on the contact surfaces, in particular of the closure element 4, are considerably reduced which, in turn, results in a reduction of the sliding forces. In this exemplary embodiment, the closure arrangement 1 according to the invention is designed in such a manner that in each of the third profiled elements 42 joined together to form a closure element 4, a magnet 5 is arranged in each case at the free end thereof in the hollow space 41

Said magnet 5 can be fixed in a firmly bonding manner by glueing or also by welding.

For better slideability of the closure arrangement 1 according to the invention, first profiled elements 30 designed as guide elements 3 are arranged in the top panel 22 as well as in the bottom panel 24.

A first profiled element 30 which likewise is U-shaped and designed as a guide element 3 is arranged in the bottom panel 24. The third profiled elements 42 forming the closure element 4 have a hollow space 43 in which a sliding element 8 is arranged at the free end associated with the bottom panel 24. During the movement of the closure element 4 formed from the second profiled elements 42, the sliding element 8 is moved in the second profiled element 30 designed as a guide element 3. Due to the attractive force acting between the magnet 5 arranged on the other free end of the profiled element 42 and the strip 31 arranged on the first profiled element 30 designed as a guide element 3, the weight force of the closure arrangement 4 acting on the sliding elements 8 arranged in the profiled elements 42 is reduced and the closure arrangement 1 can be moved easily and with low sliding forces.

In this exemplary embodiment, the third profiled element 42 is made from a polymeric material and is joined together by means of tongue and groove joints known per se so as to form a closure element 4 which is also designated as blind or roller shutter.

However, it lies also within the scope of the invention that the third profiled element 42 is made from a ferromagnetic material and the magnet 5 is arranged, which is not shown in this illustration, on the first profiled element 30 which is designed as a guide element 3.

It lies also within the scope of the invention that the magnet 5 is arranged between the closure element 4 and the guide element 3.

Thus, the magnet 5, which is arranged over the entire length of the first profiled element 30 designed as a guide element 3, can advantageously act as a spacer element at the same time.

1. A closure arrangement (1) for an opening (2) of a cabinet, a refrigerator, a building or the like, having at least one closure element (4) which is guided in a moveable manner, in particular in or on at least one guide element (3), over the opening (2), wherein at least one free end of the closure element (4) and/or one free end of the guide element (3) are operatively connected to one another by means of a magnetic attraction force, provided by at least one a magnet (5).

2. The closure arrangement (1) according to claim 1, wherein the magnet (5) is arranged on the closure element (4) and/or on the guide element (3).

3. The closure arrangement (1) according to claim 1 wherein the magnet (5) is designed as a permanent magnet and/or as an electromagnet.

4. The closure arrangement (1) according to claim 1, wherein the magnet (5) comprises one of a group of metals or metal alloys consisting of:
metallic alloys of iron and/or nickel and/or cobalt with additions of aluminum and/or manganese and/or silicon and/or copper;
ferrites based on metal oxides such as barium hexaferrite, strontium hexaferrite;
samarium cobalt;
neodymium-iron-boron;
mixtures thereof with polymeric materials;
and of combinations thereof with one another and the like.

5. The closure arrangement (1) according to claim 1, wherein the closure element (4) and/or the guide element (3) consist at least partially of a ferromagnetic material.

6. The closure arrangement (1) according to claim 1, wherein the closure element (4) and/or the guide element (3) comprise at least partially a ferromagnetic element.

7. The closure arrangement (1) according to claim 1, any one wherein the closure element (4) is arranged spaced apart from the guide element (3).

8. The closure arrangement (1) according to claim 1, wherein on the closure element (4) and/or on the guide element (3) at least one spacer element (6) is arranged.

9. The closure arrangement (1) according to claim 1, wherein on the closure element (4) and/or on the guide element (3) at least one sliding element (8) is arranged.

10. The closure arrangement (1) according to claim 1, wherein on the closure element (4) and/or on the guide element (3) at least one sealing element (7) is arranged.

11. The closure arrangement (1) according to claim 9, wherein the sealing element (7) seals a gap between the closure element (4) and the guide element (3) in an air-tight and/or liquid-tight manner.

12. The closure arrangement (1) according to claim 2, wherein the magnet (5) is designed as a permanent magnet and/or as an electromagnet.

13. The closure arrangement (1) according to claim 2, wherein the magnet (5) comprises one of a group of metals or metal alloys consisting of:
metallic alloys of iron and/or nickel and/or cobalt with additions of aluminum and/or manganese and/or silicon and/or copper;
ferrites based on metal oxides such as barium hexaferrite, strontium hexaferrite;
samarium cobalt;
neodymium-iron-boron;
mixtures thereof with polymeric materials;
and of combinations thereof with one another and the like.

14. The closure arrangement (1) according to claim 3, wherein the magnet (5) comprises one of a group of metals or metal alloys consisting of:
metallic alloys of iron and/or nickel and/or cobalt with additions of aluminum and/or manganese and/or silicon and/or copper;
ferrites based on metal oxides such as barium hexaferrite, strontium hexaferrite;
samarium cobalt;
neodymium-iron-boron;
mixtures thereof with polymeric materials;
and of combinations thereof with one another and the like.

15. The closure arrangement (1) according to claim 2, wherein the closure element (4) and/or the guide element (3) consist at least partially of a ferromagnetic material.

16. The closure arrangement (1) according to claim 3, wherein the closure element (4) and/or the guide element (3) consist at least partially of a ferromagnetic material.

17. The closure arrangement (1) according to claim 4, wherein the closure element (4) and/or the guide element (3) consist at least partially of a ferromagnetic material.

18. The closure arrangement (1) according to claim 2, wherein the closure element (4) and/or the guide element (3) comprise at least partially a ferromagnetic material

19. The closure arrangement (1) according to claim 3, wherein the closure element (4) and/or the guide element (3) comprise at least partially a ferromagnetic material

20. The closure arrangement (1) according to claim 4, wherein the closure element (4) and/or the guide element (3) comprise at least partially a ferromagnetic material
